(19) United States
(12) Patent Application Publication
(10) Pub. No.: US 2009/0134132 A1
(43) Pub. Date: May 28, 2009

(54) Laser Beam Welding Method with a Metal Vapour Capillary Formation Control

(75) Inventors: Eric Verna, Boissy L'Aillerie (FR); Francis Briand, Paris (FR); Sonia Slimani, Maisons Alfort (FR); Remy Fabbro, Antony (FR); Frederic Coste, Arcueil Cedex (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/090,933

(22) PCT Filed: Oct. 19, 2006
(86) PCT No.: PCT/FR2006/051058

§ 371 Date: Oct. 13, 2008

(30) Foreign Application Priority Data
Oct. 21, 2005 (FR) 0553197

(51) Int. Cl. B23K 26/20

(52) U.S. Cl. 219/121.64

(57) ABSTRACT

The invention relates to a method for welding at least one, preferably two metal parts to each other, by a laser beam consisting in using a laser beam (10), a first gas flow and a welding nozzle provided with an output orifice which is passed through by the laser beam and the first gas flow and in welding the part(s) by melting the metal thereof at a point of the laser beam impact with said weldable part(s) in such a way that a capillary (11) or a key hole (12) filled with metal vapour is formed. During welding, the first gas flow is directed only to the aperture of the metal vapour capillary in a direction perpendicular to the weldable part(s) in such a way that a dynamic gas pressure is produced.

The invention relates to a laser welding method in which the hydrodynamics of the liquid pool are controlled thanks to a gas flow focused, during the welding, on the capillary forming at the point of impact of the laser beam.

In laser beam welding, producing a weld between two workpieces is based on the phenomenon of melting and vaporization of the material at the point of impact of the laser beam.

For sufficiently high specific power densities, that is to say a few MW/cm², a capillary or keyhole filled with metal vapor forms in the material and allows a direct transfer of energy to the core of the material.

The walls of the capillary are formed of molten metal and are maintained due to a dynamic equilibrium that is established with the internal vapor. Depending on movement, the molten metal passes around the capillary to form a “liquid pool” at the rear of this.

The presence of this cavity in the core of the constantly moving liquid pool is the origin of instabilities that give rise to numerous defects likely to degrade the quality of the welding thus obtained.

In fact, observing the welding point with the help of a camera it is observed that large instabilities develop on the surface of the weld pool in contact with the ejected vapor, forming “waves”. From time to time the metal vapor ejected from the capillary also carry along droplets of liquid metal. The liquid pool may sometimes, under the action of its own weight, collapse and temporarily obstruct the capillary leading to large instabilities.

Hence the surface appearance of the weld is often very rough and jagged, while porosity appears and weakens the weld seam obtained.

In other words, the weld seams obtained are of poor quality.

The document Kamimuki et al., Prevention of welding defect by side gas flow and its monitoring method in continuous wave Nd:YAG laser welding, J. of Laser Appl., 14(3), p. 136-145, 2002, explains that a lateral gas jet emitted via a conventional cylindrical nozzle of small diameter positioned solely at the rear of the keyhole can sometimes diminish spatter and porosity in a weld seam.

However, a major problem with this solution lies in the great difficulty in positioning the nozzle. In fact, if the pressure of the gas jet is a little too high or shifted several millimeters to the rear of the capillary, it is sufficient to close the latter and increase the instabilities in the liquid pool, leading to the opposite effect from that sought.

In addition, welding can take place only in one direction with such a nozzle, which is not very practical in an industrial context where welding must be able to be carried out in several directions, depending on the complexity of the workpieces to be welded.

Furthermore, the documents JP-A-61229491, JP-A-04313485 and U.S. Pat. No. 4,684,779 propose laser welding methods with an auxiliary gas. One or more gas flows are sent toward the workpieces to be welded to evacuate the gaseous impurities found in the ambient atmosphere in the welding area. Put another way, in these documents the gas flows are delivered at low pressure and serve solely to establish a gaseous atmosphere shielding the welding area.

Such methods do not allow the quality of the weld seams produced to be improved because the gas flow or flows exert(s) pressure solely on the weld pool, forcing the molten metal toward the capillary, thus leading to a destabilization of the capillary or quite simply to its being obstructed.

The problem that arises is therefore to improve existing laser welding methods in a way that increases the quality of the weld seams, while avoiding the harmful phenomena mentioned above.

The solution of the invention must also be usable in an industrial context, that is it must be simple in its architecture and have great flexibility in use, in workpieceicular not being limited to one welding direction.

The solution of the invention is a method of laser beam welding of at least one metal workpiece, preferably of two metal workpieces with each other, in which:
a) a laser beam, a first gas flow and a welding nozzle equipped with an outlet orifice are employed, said orifice being passed through by the laser beam and by the first gas flow; and
b) the workpiece(s) are welded by melting the metal of the workpiece(s) to be welded, at the point of impact of the laser beam on the workpiece(s) to be welded, with a capillary or keyhole being formed and filled with metal vapor.

According to the invention, during welding, the first gas flow is guided solely toward the opening of the metal vapor capillary and in a direction perpendicular to the workpiece(s) to be welded so as to exert there a dynamic gas pressure and to keep the keyhole open, while widening it.

Within the context of the invention, the capillary area found at the surface of the sheet metal to be welded, and through which the metal vapor escapes, is called the “metal vapor capillary opening (or keyhole)”. As such, the diagram of FIG. 5 illustrates a longitudinal section of the welding area in the course of the process of welding by a laser beam 10. This diagram distinguishes a representation of the capillary 11 from which the metal vapor 12 escapes on the one hand, and the metal liquid walls 14 that form a pool at the rear 13 on the other hand. The arrow designates the welding direction S.

Depending on the case, the method of the invention can comprise one or more of the following features:
the first gas flow is used to exert a continuous and constant dynamic gas pressure on the opening of the vapor capillary;
the first gas flow is used to stabilize the flow of the liquid pool of molten metal;
a second flow of shielding gas, arranged peripherally around the first gas flow, is furthermore employed;
a second flow of shielding gas, arranged coaxially with the first gas flow around the axis of the laser beam, is furthermore employed;
the flow rate of the first gas is around 10 to 20 l/min and the flow rate of the second gas is around 20 to 30 l/min;
the nozzle is a coaxial nozzle;
the first and the second gases are chosen from argon, helium, nitrogen and mixtures thereof, and possibly a lower proportion of CO₂, oxygen or hydrogen;
the laser beam is generated by an Nd:YAG, ytterbium fiber or CO₂ laser generator;
the welding nozzle is carried by a robot arm;
the metal workpiece(s) to be welded are made of coated or uncoated carbon steel, aluminum or stainless steel;
the welding nozzle delivering the first gas flow has a gas flow area of between 0.1 and 10 mm²; and
the pressure of the first gas flow is between 1 and 10 kPa.

The present invention is therefore based on a stabilization of the flow of the liquid pool during welding by acting on the keyhole opening via a “fast” first gas jet or gas flow directed toward or onto said capillary opening so as to exert a dynamic gas pressure at this location in order stabilize the shape of the opening, or even enlarge it, and in this way to solve the abovementioned problems.

In fact, thanks to this dynamic pressure, the capillary remains open because the pressure of the first gas widens it and the metal vapor generated in the capillary can escape without being disturbed by the neighboring pool of molten metal.

The number of splashes is thereby found to be appreciably reduced and the hydrodynamic flow of the liquid metal made easier, leading to improved appearance of the weld seams and a reduction in porosity in the weld, since the metal vapor no longer, or far less, finds itself trapped there.

Complementary to this, a second jet of shielding gas at a lower flow rate, such as is that commonly used in laser welding, is arranged around the periphery so as to shield the weld pool from oxidation by forming a gas shield or cover around the welding area.

Put another way, the solution of the invention preferably makes use of a first “fast” stabilizing gas jet arranged symmetrically around the axis of the laser beam directed or focused on the keyhole opening and a “slow” second gas jet to cover or shield the welding area.

The focused gas is said to be “fast” if it has or acquires enough kinetic energy to exert sufficient dynamic pressure on the keyhole to keep it open. By contrast, the cover gas is said to be “slow” because it must not disturb the flow of the liquid pool, but just prevent contact of the latter with the oxygen in the ambient air.

The flow rates are around 10 to 20 l/mm for the fast first gas and 20 to 30 l/mm for the slow second cover gas. The flow cross section of the “fast” gas is typically between 0.1 and 10 mm². In fact, the diameter of the gas flow is, by several tenths of a millimeter, just greater than that of the laser beam at the nozzle outlet.

The gas flow rates involved depend directly on the density of the gas employed to obtain an effective dynamic pressure. This pressure is typically of the order of a few kPa.

The workpieceicular choice of the gas flow rates most appropriate for a given welding operation can therefore be made empirically by the person skilled in the art depending on the welding conditions desired, especially the type of material that has to be welded, the kind of gas available, and the power of the laser generator to be used.

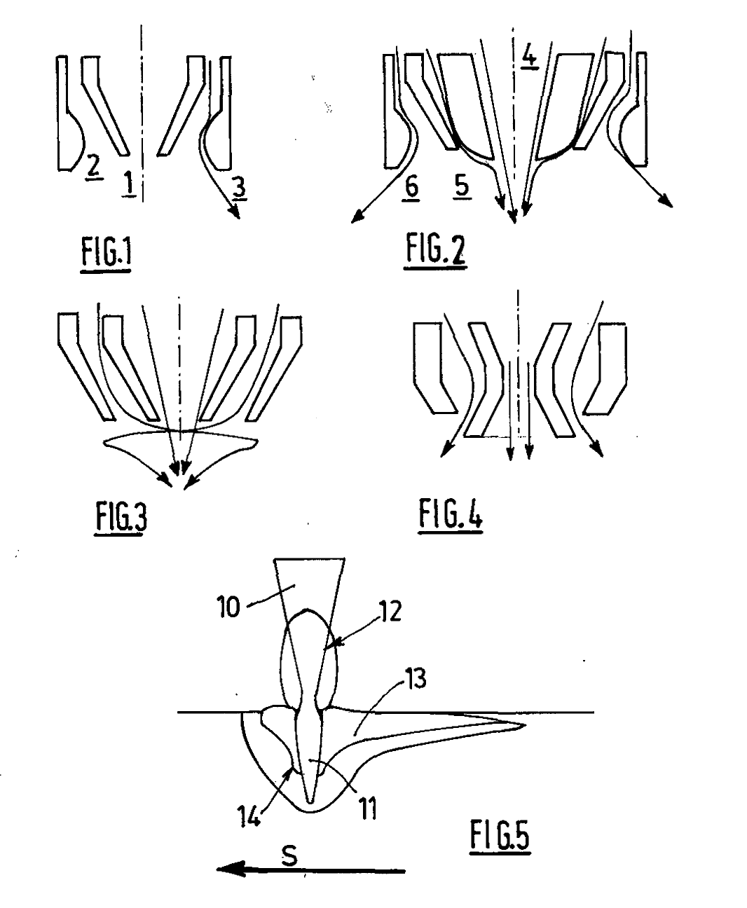

The gas jets or flows can be delivered by a single “dual flow” nozzle, that is a nozzle delivering two gas flows that are coaxial in relation to each other, also called a “coaxial” nozzle, as shown in FIGS. 1 to 4. This principle can be extended to several, in workpieceicular three, concentric gas flows.

Alternatively, the fast focusing gas may be delivered in this way by several appropriately arranged nozzles, for example by four convergent nozzles of small diameter, typically less than 3 mm, at an angle of between 20° and 45° to the axis of the beam, positioned by being regularly distributed around the periphery of a conventional annular shield nozzle delivering the “slow” gas.

It is to be noted that, preferably, identical gases are used as the first and second gas flows. However, these two gases can also be different.

Thus in Nd:YAG laser welding, argon is generally used as the gas for shielding the laser beam, while in CO₂ laser welding, helium is necessary to prevent the phenomenon of backfire.

However, for certain applications helium/nitrogen, helium/argon or any other helium-based gas mixtures may also be used for beams from CO₂ laser generators, as can any inert gas for beams from YAG or fiber laser generators.

Similarly, argon, nitrogen, helium or mixtures of these gases can be used, also with one or more additional constituents at low content (several %) such as oxygen, CO₂ or hydrogen being added.

FIGS. 1 to 4 schematically depict several embodiments of “coaxial” nozzles according to the invention.

As can be seen in FIGS. 1 to 4, a coaxial nozzle is a nozzle formed of at least two concentric gas delivery circuits.

FIG. 1 shows a first version of a coaxial nozzle. The fast gas jet is delivered at the center of the nozzle through an orifice 1 of diameter between 0.2 and 3 mm toward the keyhole opening.

The cover gas is in turn diffused in the ring 2 concentric with the opening 1. The profile of the ring 2 can be chosen so that a wall effect is obtained, that is to say that the direction of flow of the slow gas follows the curvature of the wall as shown by the vector 3.

FIG. 2 shows a version of a nozzle in which the wall effect is used to focus the flow of the fast gas along the axis of the laser beam. In this embodiment, three gas flow circuits are provided: one axial circuit 4 for a slow delivery of gas and a low flow rate, serving principally to avoid any pollution getting back into the laser optics, a first peripheral circuit 5 channeling the fast gas toward the keyhole opening and a second circuit 6 delivering the slow cover gas.

FIG. 3 illustrates an embodiment in which the gaseous cover of the slow gas is widened due to a “vortex” distribution, that is with a rotational component that tends to drive the gas horizontally at the nozzle outlet.

FIG. 4 shows a nozzle in which the fast gas is accelerated via a convergent-divergent nozzle, that is a convergent-divergent orifice.

A major interest in using a coaxial nozzle lies in its ease of positioning and its independence with regard to the direction in which the welding head carrying the nozzle can be displaced. This implies that it can be, for example, placed directly at the end of a robot arm in the case of welding with an Nd:YAG laser, where the laser beam is generated by an Nd:YAG generator before being transported via a fiber optic cable to the laser head bearing the nozzle.

In all cases, by implementing the method according to the invention with such a coaxial nozzle a first gas jet is accelerated and confined to the direction of the capillary opening, which allows the flow at the rear of the capillary to be modified.

The capillary is thus more open in the welding direction and the flow of the liquid pool is regular, continuous and without any surface oscillation.

In the case of welding with an Nd:YAG laser oscillator, the weld seam is very smooth and the “chevron structure” characteristic of Nd:YAG laser welding can be completely eliminated.

Of course, the flow rate of the gas jet must be higher than a conventional flow, but not too great, so as to avoid ejecting molten metal.

Implementing the invention additionally has the advantage of also leading to a notable increase in the penetration depth of the weld.

In this way, trials carried out with a gas jet directed at and confined to the capillary opening have shown a 25% increase in penetration.

This might be explained, considering that the capillary is lengthened by the gas jet according to the invention, by the fact that the laser beam is interrupted much less by the fluctuations of the wavefront behind the capillary.

In addition, on account of the larger capillary opening on account of the gas jet, a less dense plasma is obtained, and consequently one that absorbs the laser beam less when welding, for example, with a CO₂ laser oscillator.

The lengthening of the capillary also greatly reduces the porosity generated in the weld seam during laser welding.

When the flow of the liquid pool is stabilized via the convergent gas jet of the invention, molten metal splashes are lessened and the ejection of metal droplets can be completely eliminated.

The use of a coaxial nozzle that confines the fast gas jet to the capillary opening is able to control efficiently the hydrodynamics of the liquid pool.

The flow of the latter can therefore be very well stabilized and metal spatters completely eliminated, which allows a very high weld seam quality to be achieved with an improved penetration depth at low welding speed, that is at less than 3 m/min.

This welding method with a fast jet is therefore suited to applications of laser welding at medium thickness, that is from around 1 to 5 mm.

1-13. (canceled)

14. A method of laser beam welding of at least one metal workpiece in which:
a) a laser beam, a first gas flow and a welding nozzle equipped with an outlet orifice are employed, said orifice being passed through by the laser beam and by the first gas flow; and
b) the workpiece(s) are welded by melting the metal of the workpiece(s) to be welded, at the point of impact of the laser beam on the workpiece(s) to be welded, with a capillary or keyhole being formed and filled with metal vapor,
characterized in that during welding the first gas flow is guided solely toward the opening of the metal vapor capillary and in a direction perpendicular to the workpiece(s) to be welded so as to exert there a dynamic gas pressure and to keep the keyhole open.

15. The method of claim 14, wherein two metal workpieces are welded with each other.

16. The method of claim 14, wherein the first gas flow is used to exert a continuous and constant dynamic gas pressure on the opening of the vapor capillary.

17. The method of claim 14, wherein the first gas flow is used to stabilize the flow of the liquid pool of molten metal.

18. The method of claim 14, wherein a second flow of shielding gas, arranged peripherally around the first gas flow, is furthermore employed.

19. The method of claim 14, wherein a second flow of shielding gas, arranged coaxially with the first gas flow around the axis of the laser beam, is furthermore employed.

20. The method of claim 14, wherein the flow rate of the first gas is around 10 to 201/min and the flow rate of the second gas is around 20 to 301/min.

21. The method of claim 14, wherein the nozzle is a coaxial nozzle.

22. The method of claim 14, wherein the first and the second gases are chosen from argon, helium, nitrogen and mixtures thereof, and optionally a lower proportion of CO₂, oxygen or hydrogen.

23. The method of claim 14, wherein the laser beam is generated by an Nd:YAG, ytterbium fiber or CO₂ laser generator.

24. The method of claim 14, wherein the welding nozzle is carried by a robot arm.

25. The method of claim 14, wherein the metal workpiece(s) to be welded are made of coated or uncoated carbon steel, aluminum or stainless steel.

26. The method of claim 14, wherein in that the welding nozzle delivering the first gas flow has a gas flow area of between 0.1 and 10 mm².

27. The method of claim 14, wherein the pressure of the first gas flow is between 1 and 10 kPa.
